(19) United States
(12) Patent Application Publication
(10) Pub. No.: US 2024/0314882 A1
(43) Pub. Date: Sep. 19, 2024

(54) COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN); Xinlei YU, Dongguan (CN)

(73) Assignee: GUANGDONG OPPO MOBILE TELECOMMUNICATIONS CORP., LTD., Dongguan (CN)

(21) Appl. No.: 18/676,198

(22) Filed: May 28, 2024

Related U.S. Application Data
(63) Continuation of application No. PCT/CN2022/070144, filed on Jan. 4, 2022.

(51) Int. Cl. H04W 76/20; H04B 17/318; H04W 24/10; H04W 84/06

(52) U.S. Cl. CPC H04W 76/20; H04B 17/328; H04W 24/10; H04W 84/06

(57) ABSTRACT

Disclosed are a communication method, a terminal device, and a network device. The communication method includes: receiving, by a terminal device, a first parameter sent by a network device, the first parameter is used to indicate a time at which a first non-terrestrial network NTN cell stops serving a current coverage area when the terminal device is in an RRC connected state, and the first NTN cell is a special cell SpCell of the terminal device; and, in a case in which the terminal device is in the RRC connected state and before the time indicated by the first parameter, starting, by the terminal device in the RRC connected state, RRM measurement for a neighboring cell.

### CROSS-REFERENCE TO RELATED APPLICATIONS

This application is a continuation of International Application No. PCT/CN2022/070144, filed on Jan. 4, 2022, the disclosure of which is hereby incorporated by reference in its entirety.

### TECHNICAL FIELD

This application relates to the field of communications technologies, and more specifically, to a communication method, a terminal device, and a network device.

### BACKGROUND

In a case in which a special cell (SpCell) of a terminal device is a non-terrestrial network (NTN) cell, a coverage range of the NTN cell may change. Therefore, the NTN cell may not continue to serve the terminal device. In this case, a terminal device in a radio resource control (RRC) connected state may not start RRM measurement for a neighboring cell yet, so that a mobility operation such as cell reselection or handover cannot be implemented. Therefore, a proper neighboring cell cannot be selected to continue to serve the terminal device.

### SUMMARY

This application provides a communication method, a terminal device, and a network device, to resolve a problem that exists in RRM measurement when a terminal device is in an RRC connected state and a SpCell is an NTN cell.

According to a first aspect, a communication method is provided, where the method includes: receiving, by a terminal device, a first parameter sent by a network device, where the first parameter is used to indicate a time at which a first non-terrestrial network NTN cell stops serving a current coverage area when the terminal device is in an RRC connected state, and the first NTN cell is a special cell SpCell of the terminal device; and in a case in which the terminal device is in the RRC connected state and before the time indicated by the first parameter, starting, by the terminal device, radio resource management RRM measurement for a neighboring cell.

According to a second aspect, a communication method is provided, where the method includes: sending, by a network device, a first parameter to a terminal device, where the first parameter is used to indicate a time at which a first non-terrestrial network NTN cell stops serving a current coverage area when the terminal device is in an RRC connected state, and the first NTN cell is a special cell SpCell of the terminal device.

According to a third aspect, a terminal device is provided, where the terminal device includes: a first receiving unit, configured to receive a first parameter sent by a network device, where the first parameter is used to indicate a time at which a first non-terrestrial network NTN cell stops serving a current coverage area when the terminal device is in an RRC connected state, and the first NTN cell is a special cell SpCell of the terminal device; and a first starting unit, configured to start radio resource management RRM measurement for a neighboring cell in a case in which the terminal device is in the RRC connected state and before the time indicated by the first parameter.

According to a fourth aspect, a network device is provided, including: a first sending unit, configured to send a first parameter to a terminal device, where the first parameter is used to indicate a time at which a first non-terrestrial network NTN cell stops serving a current coverage area when the terminal device is in an RRC connected state, and the first NTN cell is a special cell SpCell of the terminal device.

According to a fifth aspect, a terminal device is provided, including a processor, a memory, and a communications interface. The memory is configured to store one or more computer programs, and the processor is configured to invoke the computer program in the memory to cause the terminal device to execute the method according to the first aspect.

According to a sixth aspect, a network device is provided, including a processor, a memory, and a communications interface. The memory is configured to store one or more computer programs, and the processor is configured to invoke the computer program in the memory to cause the network device to execute the method according to the second aspect.

According to a seventh aspect, an embodiment of this application provides a communications system, where the system includes the foregoing terminal device and/or the foregoing network device. In another possible design, the system may further include another device that interacts with the terminal or the network device in the solutions provided in embodiments of this application.

According to an eighth aspect, an embodiment of this application provides a computer-readable storage medium, where the computer-readable storage medium stores a computer program, and the computer program causes a terminal device to execute some or all of the steps in the method according to the first aspect.

According to a ninth aspect, an embodiment of this application provides a computer-readable storage medium, where the computer-readable storage medium stores a computer program, and the computer program causes a network device to execute some or all of the steps in the method according to the second aspect.

According to a tenth aspect, an embodiment of this application provides a computer program product, where the computer program product includes a non-transitory computer-readable storage medium that stores a computer program, and the computer program is operable to cause a terminal to execute some or all of the steps of the method according to the first aspect. In some implementations, the computer program product may be a software installation package.

According to an eleventh aspect, an embodiment of this application provides a computer program product, where the computer program product includes a non-transitory computer-readable storage medium that stores a computer program, and the computer program is operable to cause a network device to execute some or all of the steps in the method according to the second aspect. In some implementations, the computer program product may be a software installation package.

According to a twelfth aspect, an embodiment of this application provides a chip, where the chip includes a memory and a processor, and the processor may invoke a computer program from the memory and run the computer program, to implement some or all of the steps described in the method according to the first aspect or the second aspect.

According to a thirteenth aspect, a computer program product is provided, including a program, where the program causes a computer to execute the method according to the first aspect.

According to a fourteenth aspect, a computer program product is provided, including a program, where the program causes a computer to execute the method according to the second aspect.

According to a fifteenth aspect, a computer program is provided, where the computer program causes a computer to execute the method according to the first aspect.

According to a sixteenth aspect, a computer program is provided, where the computer program causes a computer to execute the method according to the second aspect.

According to a first parameter, a terminal device in an RRC connected state may start RRM measurement for a neighboring cell before a first NTN cell stops serving a current coverage area. In a process of executing the RRM measurement for a neighboring cell, the terminal device may find a proper candidate neighboring cell as soon as possible through the RRM measurement for a neighboring cell, so that the terminal device may be handed over to another cell before the first NTN cell stops serving. This better meets a mobility management requirement of the terminal device.

### BRIEF DESCRIPTION OF DRAWINGS

FIG. 1 shows a wireless communications system to which embodiments of this application are applicable.

FIG. 2 is a schematic diagram of a satellite network architecture.

FIG. 3 is a schematic diagram of another satellite network architecture.

FIG. 4 is a schematic flowchart of a communication method according to an embodiment of this application.

FIG. 5 is a schematic diagram of a time axis for RRM measurement according to an embodiment of this application.

FIG. 6 is a schematic diagram of another time axis for RRM measurement according to an embodiment of this application.

FIG. 7 is a schematic diagram of still another time axis for RRM measurement according to an embodiment of this application.

FIG. 8 is a schematic structural diagram of a terminal device according to an embodiment of this application.

FIG. 9 is a schematic structural diagram of a network device according to an embodiment of this application.

FIG. 10 is a schematic structural diagram of an apparatus according to an embodiment of this application.

### DESCRIPTION OF EMBODIMENTS

The following describes the technical solutions in this application with reference to the accompanying drawings.

### Communications System

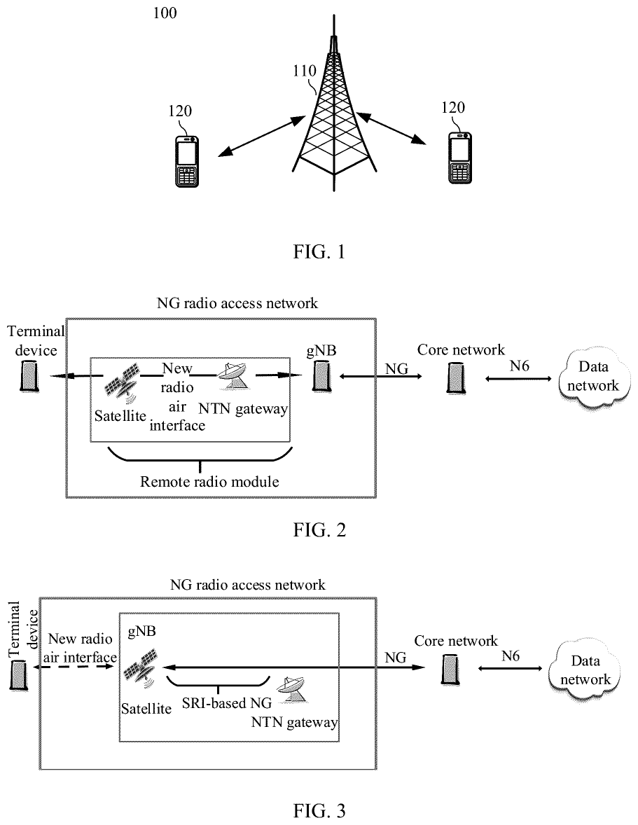

FIG. 1 shows a wireless communications system 100 to which embodiments of this application are applicable. The wireless communications system 100 may include a network device 110 and a terminal device 120. The network device 110 may be a device that communicates with the terminal device 120. The network device 110 may provide communication coverage for a specific geographic area, and may communicate with a terminal device 120 within the coverage area.

FIG. 1 exemplarily shows one network device and two terminals. Optionally, the wireless communications system 100 may include a plurality of network devices, and another quantity of terminal devices may be included in a coverage range of each network device, which is not limited in embodiments of this application.

Optionally, the wireless communications system 100 may further include another network entity such as a network controller or a mobility management entity, which is not limited in embodiments of this application.

It should be understood that the technical solutions of embodiments of this application may be applied to various communications systems, such as a 5th generation (5th generation, 5G) system or new radio (NR), a long-term evolution (LTE) system, an LTE frequency division duplex (FDD) system, and LTE time division duplex (TDD). The technical solutions provided in this application may further be applied to a future communications system, such as a 6th generation mobile communications system or a satellite communications system.

The 5G system studied by the 3rd generation partnership project (3GPP) is designed to meet people's pursuit of rate, delay, high-speed mobility, and energy efficiency, and adapt to diversity and complexity of services in future life. Main scenarios in which the 5G system is applicable include: enhanced mobile broadband (eMBB), ultra-reliable low latency communications (URLLC), and massive machine type communication (mMTC).

The terminal device in embodiments of this application may also be referred to as a user equipment (UE), an access terminal, a user unit, a user station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may be a device providing a user with voice and/or data connectivity and capable of connecting people, objects, and machines, such as a handheld device or vehicle-mounted device having a wireless connection function. The terminal device in embodiments of this application may be a mobile phone, a tablet computer, a notebook computer, a palmtop computer, a mobile internet device, a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. Optionally, a UE may be used to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relaying a communication signal by using a base station.

The network device in embodiments of this application may be a device for communicating with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover various names in the following, or replace with the following names, for example: a NodeB, an evolved NodeB (eNB), a next generation NodeB (gNB), a relay station, an access point, a transmitting and receiving point (TRP), a transmitting point (TP), a primary MeNB, a secondary SeNB, a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device to device D2D, vehicle-to-everything (V2X), and machine-to-machine (M2M) communications, a network-side device in a 6G network, a device that functions as a base station in a future communications system, or the like. The base station may support networks of a same access technology or different access technologies. A specific technology and a specific device form used by the network device are not limited in embodiments of this application.

The base station may be fixed or mobile. For example, a helicopter or an unmanned aerial vehicle may be configured to function as a mobile base station, and one or more cells may move depending on a location of the mobile base station. In other examples, a helicopter or an unmanned aerial vehicle may be configured to function as a device in communication with another base station.

In some deployments, the network device in embodiments of this application may be a CU or a DU, or the network device includes a CU and a DU. A gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of this application, a scenario in which the network device and the terminal device are located is not limited.

It should be understood that all or some of functions of the communications device in this application may also be implemented by software functions running on hardware, or by virtualization functions instantiated on a platform (for example, a cloud platform).

### Radio Resource Control State

In a communications system (for example, an NR system), an RRC state of a terminal device may include an RRC connected state and an RRC non-connected state. The RRC connected state may include an RRC_connected state (RRC_CONNECTED). The RRC non-connected state may include an RRC_idle state (RRC_IDLE) and/or an RRC_inactive state (RRC_INACTIVE), and the like.

In RRC_IDLE, there is no RRC connection between the terminal device and a network device. Mobility of the terminal device is mainly reflected in cell reselection based on the terminal device. In RRC_IDLE, a paging process of the network device for the terminal device is initiated by a core network (CN), and a paging area is configured by the CN. In addition, in RRC_IDLE, an access stratum (AS) context of the terminal device does not exist in the network device.

In the RRC_CONNECTED state, there is an RRC connection between the terminal device and the network device. Both the network device and the terminal device store the AS context of the terminal device. In RRC_CONNECTED, a location of the terminal device that may be learned by the network device is a location at a level of a cell. In RRC_CONNECTED, unicast data may be transmitted between the terminal device and the network device, and the mobility of the terminal device is managed and controlled by the network device.

The RRC_INACTIVE state may reduce air interface signalling of the communications system. The terminal device in the RRC_INACTIVE state may quickly restore a wireless connection, and may also quickly restore a data service. In RRC_INACTIVE, there is a connection between the CN and the NR. The AS context of the terminal device is stored on a specific network device. In addition, in RRC_INACTIVE, a paging process of the network device for the terminal device may be triggered by a RAN, and a paging area based on the RAN may be managed by the RAN. In addition, in RRC_INACTIVE, the location of the terminal device that may be learned by the network device is a location at a level of the paging area based on the RAN.

### RRM Measurement

A terminal device may perform RRM measurement for a serving cell and a neighboring cell, to support a mobility operation. The mobility operation may include, for example, cell reselection, cell handover, or the like.

When the terminal device is in different RRC states, the RRM measurement may be different. The following separately uses examples to describe RRM measurement that may be performed by the terminal device when the terminal device is in an RRC connected state and an RRC non-connected state. In some embodiments, RRM measurement may also be referred to as measurement.

### RRM Measurement of the Terminal Device in the RRC Non-Connected State

For the terminal device in the RRC non-connected state, the network device may configure the terminal device, to implement RRM measurement.

RRM measurement of the terminal device in the RRC non-connected state for the serving cell may be continuous.

RRM measurement of the terminal device in the RRC non-connected state for a neighboring cell may not be continuous. The following uses examples to describe how to implement discontinuous RRM measurement.

In some communications systems (for example, in an NR Rel-15 communications system), when quality of a channel of the terminal device in the serving cell is good, for an intra-frequency frequency and an inter-frequency or inter-technology frequency with a same priority or a low priority, the terminal device may not start RRM measurement for a point, or the terminal device may execute relaxed RRM measurement for an inter-frequency or inter-technology frequency with a high priority.

In an implementation, for an intra-frequency frequency, if Srxlev measured for the serving cell is greater than SIntraSearchP and Squal is greater than SIntraSearchQ, the terminal device may disable measurement for all intra-frequency neighboring cells.

In another implementation, for an inter-frequency frequency with a low priority or a same priority in a same communications system or a frequency in a different communications system, if Srxlev measured for the serving cell is greater than SnonIntraSearchP and Squal is greater than SnonIntraSearchQ, the terminal device may disable measurement for all inter-frequency frequencies in the same communications system or all frequencies in the different communications system.

In still another implementation, for an NR inter-frequency or inter-technology frequency with a high priority, if Srxlev measured for the serving cell is greater than SnonIntraSearchP and Squal is greater than SnonIntraSearchQ, the terminal device may execute relaxed RRM measurement for an inter-frequency frequency with a high priority in a same communications system or a frequency in a different communications system. The relaxed RRM measurement may be, for example, for each high-priority frequency, a measurement interval may be relaxed to Thigher_priority_search=(60*Nlayers) seconds, where Nlayers may be a quantity of high-priority frequencies that are broadcast by a network.

In the foregoing implementations, the parameters SIntraSearchP, SIntraSearchQ, SnonIntraSearchP, and SnonIntraSearchQ may be configured by the network device by using a system information block (SIB) 2.

### RRM Measurement of the Terminal Device in the RRC Connected State

The network device may send RRM measurement configuration to the terminal device. The terminal device may detect a signal quality status of the neighboring cell according to at least one parameter in a measurement object indicated in the measurement configuration, reporting configuration, or the like, and may further feed measurement reporting information back to the network device. The network device may perform a handover or complete a neighboring cell relationship list based on the measurement reporting information.

In some communications systems (for example, a 5G system), a network may configure, for the terminal device in the RRC connected state, synchronization signal/physical broadcast channel block (SSB) measurement and channel state information reference signal (CSI-RS) measurement. The SSB measurement and the CSI-RS measurement may have different measurement configuration. For example, for the SSB measurement, an SSB frequency associated with a measurement object may be configured. Some communications systems (for example, the 5G system) may support transmission of a plurality of different subcarrier spacings. Therefore, an SSB subcarrier spacing related to measurement needs to be indicated in the measurement object. Alternatively, for the CSI-RS measurement, a reference frequency at which a measurement object maps a CSI-RS to a physical resource may be configured. For measurement configuration of an SSB reference signal, the measurement object may further additionally indicate time window information of the SSB measurement, that is, SSB-based RRM measurement timing configuration (ssb based rrm measurement timing configuration, SMTC) information. In addition, the network device may further indicate information such as several SSBs (for example, SSB-ToMeasure) measured by the terminal device in the SMTC. For measurement configuration of a CSI-RS reference signal, the measurement object may include configuration of a CSI-RS resource.

The measurement configuration may include an S-measure threshold parameter, to implement power saving of the terminal device. The S-measure threshold parameter may be, for example, a reference signal received power (RSRP) value. The terminal device may compare the S-measure threshold parameter with a SpCell measurement value, to determine whether an S-measure criterion is met. When a SpCell meets the S-measure criterion, the terminal device may not execute measurement for a non-serving cell. When the SpCell does not meet the S-measure criterion, the terminal device may execute the measurement for a non-serving cell. In an implementation, when an RSRP measurement value of the SpCell is less than the S-measure threshold, the S-measure criterion is not met, and the terminal device may execute the measurement for a non-serving cell. In addition, when the RSRP measurement value of the SpCell is not less than the S-measure threshold, the S-measure criterion is met, and the terminal device may not execute the measurement for a non-serving cell. For some communications systems (for example, the 5G system) that may support SSB measurement and CSI-RS measurement, when configuring a threshold value of S-measure, the network device may indicate whether the threshold parameter is for an RSRP value of an SSB or an RSRP value of CSI.

### NTN

An NTN provides a user with a communication service in a non-terrestrial (for example, satellite) manner.

For terrestrial network communication, in a scenario such as a sea, a mountain, or a desert, a communications device cannot be set up for land communication. Alternatively, considering construction and operation costs of the communications device, land communication generally does not cover a sparsely populated area. The NTN has many advantages over terrestrial network communication. First, NTN communication may not be limited by a user area. The NTN communications network is not limited by an area. In theory, a satellite may orbit the earth, so every corner of the earth may be covered by satellite communication. In addition, an area that may be covered by an NTN communications device is far larger than an area covered by a terrestrial communications device. For example, in satellite communication, a satellite may cover a relatively large terrestrial area. Second, NTN communication has a great social value. NTN communication may implement coverage at a low cost, for example, may cover remote mountains or poor and backward countries or regions at a low cost by using satellite communication. This enables people in these regions to enjoy advanced voice communication and mobile internet technologies, which helps narrow a digital divide with developed regions and promote development of these regions. Third, a communication distance of NTN communication is long, and a communication cost is not significantly increased. In addition, NTN communication has high stability. For example, NTN communication may not be limited by a natural condition, and may be used even in a case of a natural disaster.

### Communications Satellite

According to different orbital altitudes, communications satellites may be classified into a low-earth orbit (LEO) satellite, a medium-earth orbit (MEO) satellite, a geostationary earth orbit (GEO) satellite, a high elliptical orbit (HEO) satellite, and the like. The following describes the LEO satellite and the GEO satellite in detail.

An orbit height of the LEO satellite ranges from 500 km to 1500 km. An orbital period is about 1.5 hours to 2 hours. A signal propagation delay of single-hop communication between users is generally less than 20 ms. A maximum satellite visible time is 20 minutes. A signal propagation distance is short, a link loss is small, and a transmit power requirement for a user terminal is not high.

An orbit height of the GEO satellite is 35786 km. A rotation period of the GEO satellite around the earth is 24 hours. A signal propagation delay of single-hop communication between users is generally 250 ms.

To ensure coverage of a satellite and improve a system capacity of an entire satellite communications system, the satellite may use a plurality of beams to cover the ground. For example, one satellite may form dozens or even hundreds of beams to cover the ground. One satellite beam may cover a terrestrial area of tens to hundreds of kilometers in diameter.

### Satellite Network Architecture

An NTN network may be implemented based on a satellite network architecture.

The satellite network architecture may include the following network elements: a gateway, a feeder link, a service link, a satellite, an inter-satellite link, and the like.

There may be one or more gateways. The gateway may be configured to connect a satellite to a terrestrial public network. The gateway is usually located on the ground.

The feeder link may be a link for communication between the gateway and the satellite.

The service link may be a link for communication between a terminal device and the satellite.

The satellite may be classified into a transparent payload satellite and a regenerative payload satellite.

The inter-satellite link may exist in a regenerative payload network architecture.

FIG. 2 is a schematic diagram of a network architecture based on a transparent payload satellite. The transparent payload satellite may provide radio frequency filtering, frequency conversion, and amplification. The transparent payload satellite only provides transparent forwarding of signals, and does not change waveform signals forwarded by the satellite.

FIG. 3 is a schematic diagram of a network architecture based on a regenerative payload satellite. The regenerative payload satellite may provide radio frequency filtering, frequency conversion, and amplification. The regenerative payload satellite may further provide at least one of the following functions: demodulation or decoding, routing or conversion, and coding or modulation. It may be understood that the regenerative payload satellite may have some or all of functions of a base station. A radio link between the satellite and a gateway is a feeder link.

An architecture discussed in 3GPP is used as an example. According to different functions carried on the satellite, a regenerative payload satellite network architecture may be based on a gNB bearer, based on a gNB-distributed unit (gNB-DU) bearer, or based on an integrated access and backhaul like (IAB-like) bearer architecture. FIG. 3 is a schematic diagram of a regenerative payload satellite network architecture based on a gNB bearer.

### RRM Measurement in an NTN Scenario

In a non-GEO scenario (such as LEO, MEO, or the like) of an NTN, NTN cells may include an earth moving cell and a quasi-earth fixed cell. In a scenario of an earth moving cell, a direction of a satellite beam remains unchanged, and a terrestrial cell covered by a satellite moves with movement of the satellite. In a scenario of a quasi-earth fixed cell, in a movement process of a satellite, a direction of a satellite beam may be adjusted, so that a terrestrial cell covered by the satellite remains unchanged within a period of time.

It may be learned that a coverage range of an NTN cell may change. Therefore, within a coverage range, the NTN cell may normally serve a terminal device within the range for a limited time. For example, in a case in which a SpCell of the terminal device is an NTN cell, in a process in which a coverage range of the NTN cell changes, a case in which the NTN cell cannot continue to serve the terminal device may exist. For example, the NTN cell cannot continue to cover a current area, and therefore cannot continue to serve the terminal device. In this case, the terminal device may not start RRM measurement for a neighboring cell yet, so that a mobility operation such as cell reselection or handover cannot be implemented. Therefore, a proper neighboring cell cannot be selected to continue to serve the terminal device.

For a terminal device in an RRC non-connected state, a related technology proposes an RRM measurement solution for a scenario of a quasi-earth fixed cell. For example, the RAN2 conference proposes that a network device may broadcast a t-service (t-Service) parameter. The t-Service parameter may be used to indicate a time at which an NTN cell stops serving a current coverage area. The t-Service parameter may affect a measurement behavior of a terminal device in an RRC non-connected state for a neighboring cell. For example, if the network device broadcasts t-Service, the terminal device starts RRM measurement for a neighboring cell before t-Service, regardless of whether the terminal device meets a condition for starting the measurement for a neighboring cell.

However, for a terminal device in an RRC connected state, a problem of an RRM measurement abnormality caused by a change in a coverage range of an NTN cell still occurs. This application provides a communication method to resolve the foregoing problem.

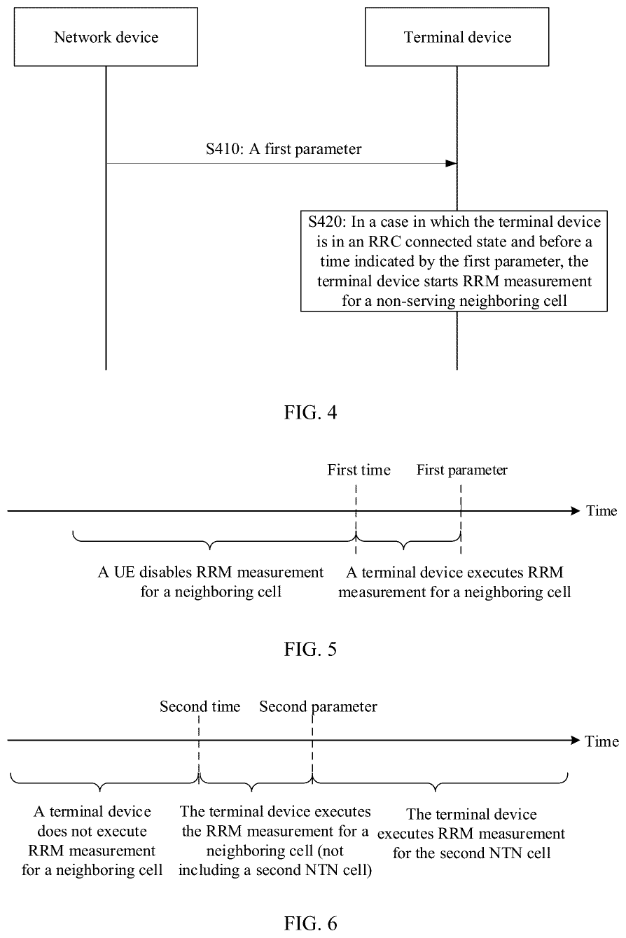

FIG. 4 is a schematic flowchart of a communication method according to an embodiment of this application. The method shown in FIG. 4 may be executed by a terminal device and a network device. The method shown in FIG. 4 may include step S410 and step S420.

Step S410: The network device sends a first parameter to the terminal device.

The first parameter may be used to indicate a time at which a first NTN cell stops serving a current coverage area when the terminal device is in an RRC connected state. The first NTN cell is a SpCell of the terminal device.

The network device may transmit the first parameter to the terminal device in a manner of a system broadcast and/or dedicated signalling of the terminal device. The dedicated signalling of the terminal device may include RRC signalling and/or medium access control control element (MAC CE) signalling.

In an implementation, the first parameter may further be used to indicate a time at which the first NTN cell stops serving the current coverage area when the terminal device is in an RRC non-connected state. For example, the first parameter may be the t-Service parameter for the RRC non-connected state in the foregoing. It may be understood that, regardless of whether the terminal device is in the RRC connected state or the RRC non-connected state, the network device may use a same parameter to indicate the time at which the first NTN cell stops serving the current coverage area. This may reduce signalling overheads of a system, and therefore save communication resources.

In another implementation, the first parameter may be a newly introduced parameter. For example, the first parameter may be a t-Service parameter for the RRC connected state. That is, the first parameter may be a parameter different from the t-Service parameter for the RRC non-connected state in a related technology. It may be understood that, for the first NTN cell, a value of the first parameter may be the same as or different from a value of the t-Service parameter for the RRC non-connected state.

It may be understood that different parameters for a time at which an NTN cell stops serving a current coverage area are respectively set for the RRC non-connected state and the RRC connected state. This may meet different measurement requirements of the RRC connected state and the RRC non-connected state.

Step S420: In a case in which the terminal device is in the RRC connected state and before the time indicated by the first parameter, the terminal device starts RRM measurement for a neighboring cell.

It may be understood that a first time at which the terminal device starts the RRM measurement for a neighboring cell may be any time before the time indicated by the first parameter. The first time may be determined by the terminal device. Therefore, the method shown in FIG. 4 may further include: determining, by the terminal device according to the first parameter, the time at which the RRM measurement for a neighboring cell is started.

It may be understood that starting the RRM measurement for a neighboring cell may be starting the RRM measurement for all neighboring cells, or may be starting the RRM measurement for some neighboring cells. Neighboring cells or a neighboring cell for which the RRM measurement is specifically started may be flexibly determined according to a neighboring cell situation.

FIG. 5 is a schematic diagram of a time axis for a terminal device to start RRM measurement for a neighboring cell according to an embodiment of this application. The terminal device may determine a first time according to a first parameter. The first time may be any time earlier than the first parameter. Before the first time, the terminal device may disable RRM measurement for a neighboring cell. At the first time, the terminal device may start the RRM measurement for a neighboring cell. Within a time period from the first time to the first parameter, the terminal device may execute the RRM measurement for a neighboring cell.

Optionally, in a case in which a network device sets an S-measure criterion and the first parameter for the terminal device, the terminal device starts the RRM measurement for a neighboring cell before the first parameter starts regardless of whether a first NTN cell meets the S-measure criterion. That is, in a case in which an RSRP measurement value of the first NTN cell is not less than an S-measure measurement threshold, the terminal device may start the RRM measurement for a neighboring cell according to the first parameter.

Specific content of the S-measure criterion is not limited in this application. For example, the S-measure criterion may include an S-measure criterion based on channel measurement (for example, RSRP) and/or S-measure based on a location of the terminal device.

According to the first parameter, the terminal device in an RRC connected state may start the RRM measurement for a neighboring cell before the first NTN cell stops serving a current coverage area. In a process of executing the RRM measurement for a neighboring cell, the terminal device may find a proper candidate neighboring cell as soon as possible through the RRM measurement for a neighboring cell, so that the terminal device may be handed over to another cell before the first NTN cell stops serving. This better meets a mobility management requirement of the terminal device.

The foregoing describes a method for starting RRM measurement for a neighboring cell when a SpCell is an NTN cell. When a neighboring cell is an NTN cell, RRM measurement for the NTN cell also has some problems. For example, when the terminal device executes the RRM measurement for the neighboring cell, the neighboring cell may not serve the terminal, for example, the neighboring cell has not covered the terminal device yet. In this case, the RRM measurement of the terminal device for the neighboring cell is unnecessary, which causes useless energy consumption of the terminal device.

For the foregoing problem, this application proposes that the terminal device may obtain a second parameter. The second parameter may be used to indicate a time at which a second NTN cell starts to serve a current coverage area. The second NTN cell may be a neighboring cell of the terminal device.

The terminal device may determine, according to an indication of the second parameter, a time at which RRM measurement for the second NTN cell starts to be executed. If the terminal device determines a second time at which RRM measurement for a neighboring cell is started (for example, the terminal device may determine the second time according to the first parameter), the time of the RRM measurement for the second NTN cell may be determined according to both the second time and the second parameter.

In an implementation, if the terminal device has started the RRM measurement for a neighboring cell before the time indicated by the second parameter, that is, the second time is earlier than the time indicated by the second parameter, the terminal device may start to execute the RRM measurement for the second NTN cell at the time indicated by the second parameter or after the time indicated by the second parameter.

FIG. 6 is a schematic diagram of a time axis for a terminal device to start RRM measurement for a second NTN cell according to an embodiment of this application. As shown in FIG. 6, in a case in which a second time is earlier than a time indicated by a second parameter, the terminal device may not execute the RRM measurement for the second NTN cell within a time period between the second time and the second parameter. At the time indicated by the second parameter or after the time indicated by the second parameter, the terminal device may start to execute the RRM measurement for the second NTN cell.

In another implementation, if the terminal device does not start RRM measurement for a neighboring cell before the time indicated by the second parameter, that is, the second time is not earlier than the time indicated by the second parameter, the terminal device starts to execute the RRM measurement for the second NTN cell at the time when the terminal device starts the RRM measurement for a neighboring cell.

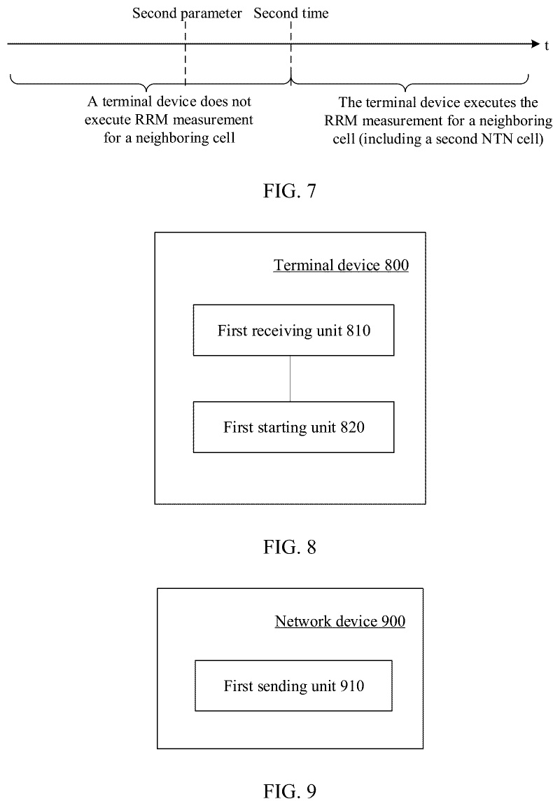

FIG. 7 is a schematic diagram of another time axis for a terminal device to start RRM measurement for a second NTN cell according to an embodiment of this application. As shown in FIG. 7, in a case in which a second time is not earlier than a time indicated by a second parameter, the terminal device may not execute RRM measurement for a neighboring cell (including the second NTN cell) before the second time. After the second time, the terminal device may execute RRM measurement for one or more neighboring cells including the second NTN cell.

A method for determining the second time is not limited in this application. For example, the second time may be a time at which the RRM measurement for a neighboring cell is started as determined according to the first parameter in the foregoing. Alternatively, the second time may be a time at which the RRM measurement for a neighboring cell is determined to be started in a related technology.

The terminal device may start to execute the RRM measurement for the second NTN cell at the time indicated by the second parameter or after the time indicated by the second parameter. Therefore, when the second NTN cell cannot serve the terminal device, the terminal device may avoid unnecessary measurement for the second NTN cell according to the second parameter. This reduces energy consumption of the terminal device.

For the terminal device that determines to start to execute the RRM measurement for the second NTN cell according to the second parameter, an RRC connection state of the terminal device is not limited in this application. For example, the second parameter may indicate a time at which the second NTN cell starts to serve a current area when the terminal device is in an RRC connected state. The second parameter may also indicate a time at which the second NTN cell starts to serve the current area when the terminal device is in an RRC non-connected state.

For the terminal device that determines to start to execute the RRM measurement for the second NTN cell, according to the second parameter, a type of a SpCell of the terminal device may be an NTN cell, or may be a non-NTN cell.

A manner in which the terminal device obtains the second parameter is not limited in this application. For example, the network device may directly or indirectly indicate the second parameter.

In an implementation, the network device may send the second parameter to the terminal device. That is, the network device may explicitly and directly indicate the second parameter. A manner in which the second parameter is sent is not limited in this application. For example, the second parameter may be indicated by a system broadcast and/or dedicated signalling of the terminal device. The dedicated signalling of the terminal device may include RRC signalling and/or MACCE signalling.

When the terminal device is in the RRC connected state, the second parameter may be indicated by a system broadcast and/or dedicated signalling of the terminal device. When the terminal device is in the RRC non-connected state, the second parameter may be transmitted by the network device to the terminal device in a manner of system broadcast configuration.

In another implementation, the network device may indirectly indicate the second parameter to the terminal device. For example, the network device may send a first message to the terminal device. The terminal device may derive the second parameter according to information in the first message. In some embodiments, the first message may include ephemeris information of the second NTN cell. The terminal device may derive the second parameter by using the ephemeris information of the second NTN cell.

It should be noted that, in some embodiments, the neighboring cell may also be referred to as a non-serving cell.

It should be noted that, in some embodiments, the RRC connected state may also be referred to as a connected state, and the RRC non-connected state may also be referred to as a non-connected state.

It should be noted that the first NTN cell may be an earth moving cell or a quasi-earth fixed cell. The second NTN cell may be an earth moving cell or a quasi-earth fixed cell.

The foregoing describes method embodiments of this application in detail with reference to FIG. 1 to FIG. 7. The following describes apparatus embodiments of this application in detail with reference to FIG. 8 to FIG. 10. It should be understood that the description of the method embodiments corresponds to the description of the apparatus embodiments, and therefore, for parts that are not described in detail, refer to the foregoing method embodiments.

FIG. 8 is a schematic structural diagram of a terminal device 800 according to an embodiment of this application. The terminal device 800 may include a first receiving unit 810 and a first starting unit 820.

The first receiving unit 810 may be configured to receive a first parameter sent by a network device, where the first parameter is used to indicate a time at which a first non-terrestrial network NTN cell stops serving a current coverage area when the terminal device is in an RRC connected state, and the first NTN cell is a special cell SpCell of the terminal device.

The first starting unit 820 may be configured to start radio resource management RRM measurement for a neighboring cell in a case in which the terminal device is in the RRC connected state and before the time indicated by the first parameter.

Optionally, the first parameter is further used to indicate a time at which the first NTN cell stops serving the current coverage area when the terminal device is in an RRC non-connected state.

Optionally, the first starting unit 820 may include a second starting unit, configured to start the RRM measurement for a neighboring cell in a case in which the first NTN cell meets an S-measure S-measure criterion.

Optionally, the terminal device 800 may further include a first determining unit.

The first determining unit may be configured to determine, according to the first parameter, a time at which the RRM measurement for a neighboring cell is started.

Optionally, the first parameter is indicated by a system broadcast and/or dedicated signalling of the terminal device.

Optionally, the terminal device 800 may further include an obtaining unit.

The obtaining unit may be configured to obtain a second parameter, where the second parameter is used to indicate a time at which a second NTN cell starts to serve the current coverage area, and the second NTN cell is a neighboring cell of the terminal device.

Optionally, the obtaining unit may include a second receiving unit.

The second receiving unit may be configured to receive the second parameter sent by the network device.

Optionally, the second parameter is indicated by a system broadcast and/or dedicated signalling of the terminal device.

Optionally, the obtaining unit may include a second determining unit.

The second determining unit may be configured to determine the second parameter according to ephemeris information of the second NTN cell.

Optionally, the terminal device 800 may further include a first execution unit.

The first execution unit may be configured to: if the terminal device has started the RRM measurement for a neighboring cell before the time indicated by the second parameter, start to execute RRM measurement for the second NTN cell at the time indicated by the second parameter or after the time indicated by the second parameter.

Optionally, the terminal device 800 may further include a second execution unit.

The second execution unit may be configured to: if the terminal device does not start the RRM measurement for a neighboring cell before the time indicated by the second parameter, start to execute RRM measurement for the second NTN cell at a time when the terminal device starts the RRM measurement for a neighboring cell.

FIG. 9 is a schematic structural diagram of a network device 900 according to an embodiment of this application. The network device 900 may include a first sending unit 910.

The first sending unit 910 may be configured to send a first parameter to a terminal device, where the first parameter is used to indicate a time at which a first non-terrestrial network NTN cell stops serving a current coverage area when the terminal device is in an RRC connected state, and the first NTN cell is a special cell SpCell of the terminal device.

Optionally, the first parameter is further used to indicate a time at which the first NTN cell stops serving the current coverage area when the terminal device is in an RRC non-connected state.

Optionally, the first parameter is indicated by a system broadcast and/or dedicated signalling of the terminal device.

Optionally, the network device 900 further includes a second sending unit.

The second sending unit may be configured to send a second parameter to the terminal device, where the second parameter is used to indicate a time at which a second NTN cell starts to serve the current coverage area, and the second NTN cell is a neighboring cell of the terminal device.

Optionally, the second parameter is indicated by a system broadcast and/or dedicated signalling of the terminal device.

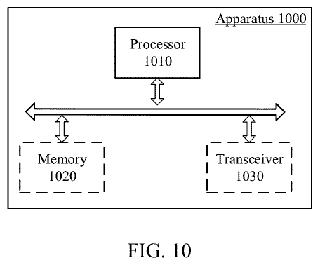

FIG. 10 is a schematic structural diagram of a communications apparatus according to an embodiment of this application. The dashed lines in FIG. 10 indicate that the unit or module is optional. The apparatus 1000 may be configured to implement the methods described in the method embodiments. The apparatus 1000 may be a chip, a terminal device, or a network device.

The apparatus 1000 may include one or more processors 1010. The processor 1010 may allow the apparatus 1000 to implement the methods described in the foregoing method embodiments. The processor 1010 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1000 may further include one or more memories 1020. The memory 1020 stores a program, where the program may be executed by the processor 1010, so that the processor 1010 executes the methods described in the foregoing method embodiments. The memory 1020 may be independent of the processor 1010 or may be integrated into the processor 1010.

The apparatus 1000 may further include a transceiver 1030. The processor 1010 may communicate with another device or chip through the transceiver 1030. For example, the processor 1010 may send and receive data to and from another device or chip through the transceiver 1030.

An embodiment of this application further provides a computer-readable storage medium for storing a program. The computer-readable storage medium may be applied to a terminal or a network device provided in embodiments of this application, and the program causes a computer to execute the methods to be executed by the terminal or the network device in various embodiments of this application.

An embodiment of this application further provides a computer program product. The computer program product includes a program. The computer program product may be applied to a terminal or a network device provided in embodiments of this application, and the program causes a computer to execute the methods to be executed by the terminal or the network device in various embodiments of this application.

An embodiment of this application further provides a computer program. The computer program may be applied to a terminal or a network device provided in embodiments of this application, and the computer program causes a computer to execute the methods to be executed by the terminal or the network device in various embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and drawings of this application are used for distinguishing different objects from each other, rather than defining a specific order. In addition, the terms “include” and “have” and any variations thereof are intended to cover a non-exclusive inclusion.

In embodiments of this application, the “indication” mentioned in embodiments of this application may be a direct indication or an indirect indication, or indicate an association. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association between A and B.

In embodiments of this application, “B that is corresponding to A” means that B is associated with A, and B may be determined based on A. However, it should also be understood that, determining B based on A does not mean determining B based only on A, but instead B may be determined based on A and/or other information.

In embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “predefining” and “pre-configuration” can be implemented by pre-storing a corresponding code or table in a device (for example, including the terminal device and the network device) or in other manners that can be used for indicating related information, and a specific implementation thereof is not limited in this application. For example, pre-defining may refer to being defined in a protocol.

In embodiments of this application, the “protocol” may refer to a standard protocol in the communication field, which may include, for example, an LTE protocol, an NR protocol, and a related protocol applied to a future communications system, and this application is not limited in this regard.

In embodiments of this application, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between apparatuses or units may be implemented in electrical, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of embodiments.

In addition, function units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, wherein the method comprises:
receiving, by a terminal device, a first parameter sent by a network device, wherein the first parameter is used to indicate a time at which a first non-terrestrial network (NTN) cell stops serving a current coverage area when the terminal device is in an RRC connected state, and the first NTN cell is a special cell (SpCell) of the terminal device; and
in a case in which the terminal device is in the RRC connected state and before the time indicated by the first parameter, starting, by the terminal device, radio resource management (RRM) measurement for a neighboring cell;
wherein the first parameter is indicated by a system broadcast and/or dedicated signalling of the terminal device.

2. The method according to claim 1, wherein the first parameter is further used to indicate a time at which the first NTN cell stops serving the current coverage area when the terminal device is in an RRC non-connected state.

3. The method according to claim 1, wherein the starting, by the terminal device, RRM measurement for a neighboring cell comprises:
in a case in which the first NTN cell meets an S-measure criterion, starting, by the terminal device, the RRM measurement for a neighboring cell.

4. The method according to claim 1, wherein the method further comprises:
determining, by the terminal device according to the first parameter, a time at which the RRM measurement for a neighboring cell is started.

5. The method according to claim 1, wherein the method further comprises:
obtaining, by the terminal device, a second parameter, wherein the second parameter is used to indicate a time at which a second NTN cell starts to serve the current coverage area, and the second NTN cell is a neighboring cell of the terminal device.

6. The method according to claim 5, wherein the obtaining, by the terminal device, a second parameter comprises:
receiving, by the terminal device, the second parameter sent by the network device;
wherein the second parameter is indicated by a system broadcast and/or dedicated signalling of the terminal device.

7. The method according to claim 5, wherein the obtaining, by the terminal device, a second parameter comprises:
determining, by the terminal device, the second parameter according to ephemeris information of the second NTN cell.

8. The method according to claim 5, wherein the method further comprises:
if the terminal device has started the RRM measurement for a neighboring cell before the time indicated by the second parameter, starting, by the terminal device, to execute RRM measurement for the second NTN cell at the time indicated by the second parameter or after the time indicated by the second parameter; or
if the terminal device does not start the RRM measurement for a neighboring cell before the time indicated by the second parameter, starting, by the terminal device, to execute RRM measurement for the second NTN cell at a time when the terminal device starts the RRM measurement for a neighboring cell.

9. A network device, comprising a memory and a processor, wherein the memory is configured to store a program, and the processor is configured to invoke the program in the memory to execute the method comprising:
sending a first parameter to a terminal device, wherein the first parameter is used to indicate a time at which a first non-terrestrial network (NTN) cell stops serving a current coverage area when the terminal device is in an RRC connected state, and the first NTN cell is a special cell (SpCell) of the terminal device;
wherein the first parameter is indicated by a system broadcast and/or dedicated signalling of the terminal device.

10. The network device according to claim 9, wherein the first parameter is further used to indicate a time at which the first NTN cell stops serving the current coverage area when the terminal device is in an RRC non-connected state.

11. The network device according to claim 9, wherein the method further comprises:
sending a second parameter to the terminal device, wherein the second parameter is used to indicate a time at which a second NTN cell starts to serve the current coverage area, and the second NTN cell is a neighboring cell of the terminal device.

12. The network device according to claim 11, wherein the second parameter is indicated by a system broadcast and/or dedicated signalling of the terminal device.

13. A terminal device, comprising a memory and a processor, wherein the memory is configured to store a program, and the processor is configured to invoke the program in the memory to execute the method comprising:
receiving a first parameter sent by a network device, wherein the first parameter is used to indicate a time at which a first non-terrestrial network (NTN) cell stops serving a current coverage area when the terminal device is in an RRC connected state, and the first NTN cell is a special cell (SpCell) of the terminal device; and
in a case in which the terminal device is in the RRC connected state and before the time indicated by the first parameter, starting radio resource management (RRM) measurement for a neighboring cell;
wherein the first parameter is indicated by a system broadcast and/or dedicated signalling of the terminal device.

14. The terminal device according to claim 13, wherein the first parameter is further used to indicate a time at which the first NTN cell stops serving the current coverage area when the terminal device is in an RRC non-connected state.

15. The terminal device according to claim 13, wherein the starting RRM measurement for a neighboring cell comprises:
in a case in which the first NTN cell meets an S-measure criterion, starting the RRM measurement for a neighboring cell.

16. The terminal device according to claim 13, wherein the method further comprises:
determining according to the first parameter, a time at which the RRM measurement for a neighboring cell is started.

17. The terminal device according to of claim 13, wherein the method further comprises:
obtaining a second parameter, wherein the second parameter is used to indicate a time at which a second NTN cell starts to serve the current coverage area, and the second NTN cell is a neighboring cell of the terminal device.

18. The terminal device according to claim 17, wherein the obtaining a second parameter comprises:
receiving the second parameter sent by the network device;
wherein the second parameter is indicated by a system broadcast and/or dedicated signalling of the terminal device.

19. The terminal device according to claim 17, wherein the obtaining a second parameter comprises:
determining the second parameter according to ephemeris information of the second NTN cell.

20. The terminal device according to claim 17, wherein the method further comprises:
if the terminal device has started the RRM measurement for a neighboring cell before the time indicated by the second parameter, starting to execute RRM measurement for the second NTN cell at the time indicated by the second parameter or after the time indicated by the second parameter; or
if the terminal device does not start the RRM measurement for a neighboring cell before the time indicated by the second parameter, starting to execute RRM measurement for the second NTN cell at a time when the terminal device starts the RRM measurement for a neighboring cell.
